(19) United States
(12) Patent Application Publication
(10) Pub. No.: US 2010/0212212 A1
(43) Pub. Date: Aug. 26, 2010

(54) Electronic Insect Detouring Device Attachable to Domestic Object and Method for Use Thereof

(75) Inventor: Zalman Peles, Corazim (IL)

Correspondence Address: The Law Office of Michael E. Kondoudis, 888 16th Street, N.W., Suite 800, Washington, DC, 20006, US

(73) Assignee: SHAHAR & PELES TECHNOLOGY DEVELOPMENT LTD., Carmiel (IL)

(21) Appl. No.: 12/682,826

(22) PCT Filed: Oct. 22, 2008
(86) PCT No.: PCT/IL08/01380

§ 371 Date: Apr. 13, 2010

(30) Foreign Application Priority Data
Oct. 15, 2007 (IL) 186667

(51) Int. Cl. A01M 1/22; A01K 29/00

(52) U.S. Cl. 43/112; 119/61.53

(57) ABSTRACT

The present invention provides an electronic device for deterring insects, said electronic device being attachable to any domestic object; said electronic device comprising: (a) a bipolar source of electrical energy; and, (b) at least two conductors in electrical communication with said bipolar source; wherein said insect deterrence is obtained by constantly providing frequently oscillated high-voltage applied by said bipolar source to said conductors such that the maximum current obtained from said bipolar source is limited to a level harmless for men and pets.

### FIELD OF THE INVENTION

The present invention relates to insect detouring devices and more particularly pertains to insect detouring devices preventing crawling insects from gaining access to the domestic objects.

### BACKGROUND OF THE INVENTION

As known human and animal food stored and prepared for use as a bait for all kinds of vermin residing in a human house. Insects penetrate into containers used for provision storage and spoil it.

Pet owners sometimes fill their pets dish with food to be eaten over long intervals, especially when they leave their homes for work or another reason. They provide their pets with enough food and water for the duration of their absence.

In many cases ants and other wingless insects penetrate into the pet dish filled with food. The pets abandon their food while insects are present in the pet dish. It is known that even after removing the insects from the pet dish, insects' distinctive smell hinder from pets' eating. Additionally, food reserve such as sacks filled with grain or animal fodder stored at farms is vulnerable to insect invasion.

Another example is concerned with penetration of insects into food bins, packages or dishes that are put on a picnic table or table clothes spread out on the ground.

The use of insect detouring systems is known in the prior art. More specifically, the insect detouring systems heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. Nos. 4,827,874, 5,107,620, and 6,848,392. The aforementioned patents disclose electrical protection of domestic objects such as pet dish and a table cloth adapted to rest upon a ground or a floor.

Electrified domestic objects for preventing crawling insects from gaining access to food or water comprise at least one electrically insulated pair of parallel electrically conductive strips secured connected to a low voltage DC battery The strips of electrical conductive material are spaced apart sufficient to normally prevent completion of a circuit across the strips and for completion of a circuit across said strips through an insect's body as the insect attempts to traverse the strips when crawling up the side wall. The current passing through the insect body is sufficient to produce a sensation which will discourage further travel up in the direction of food. A pet or human who may come into contact with the strips will usually not feel the current, and even if the pet or human is wet, the current will produce only a slight tingling sensation. The electrical apparatus may also be provided in kit form to be installed on conventional dishes by the consumer.

As known electrical damaging effect rises with the voltage between conductive strips. A cost-effective solution is a substitution of low direct voltage applied to conductive strips by high-voltage low-frequency impulses. Intensification of the detouring effect is hence a long-felt need.

### SUMMARY OF THE INVENTION

It is one object of the present invention to provide an electronic device for deterring of insects, said electronic device being attachable to any domestic object; said electronic device comprising:
(a) a bipolar source of electrical energy; and,
(b) at least two conductors electrically connected to said bipolar source;
   wherein said insect deterrence is obtained by constantly providing frequently oscillated high-voltage applied by said bipolar source to said conductors such that the maximum current obtained from said bipolar source is limited to a level harmless for a man and a pet and yet unbearable by insects.

It is another object of the present invention to provide the electronic device as defined above, wherein said conductors being disposed in parallel engirdle an external perimeter of said domestic object; said conductors are spaced apart at a distance adapted for normal prevention of circuit completion without insect and circuit completion by insect's traversing said conductors.

It is another object of the present invention to provide the electronic device as defined above, wherein said source of electrical energy comprises (a) a low voltage direct current source, (b) an up converter providing alternating high voltage, (c) a rectifier, and (d) a capacitor; said current source, up converter and rectifier are connected in series; leads of said rectifier are bridged by said capacitor.

It is another object of the present invention to provide the electronic device as defined above, wherein said conductors are connected to leads of said rectifier.

It is another object of the present invention to provide the electronic device as defined above, wherein said up converter comprises a generator of alternating pulses and a step-up transformer.

It is another object of the present invention to provide the electronic device as defined above, wherein said current source is a galvanic battery.

It is another object of the present invention to provide the electronic device as defined above, wherein said current source is a low voltage direct current power supply powered by public network.

It is another object of the present invention to provide the electronic device as defined above, wherein said device comprises an electrical strap embracing said domestic object; a length of said strap is adapted for a tight attachment to said domestic object; end portions of said strap are furnished with releasable interlock able members; said strap comprises at least two conductors charged oppositely.

It is another object of the present invention to provide an electronic insect-proof domestic system comprising a domestic object and at least one electronic device; said domestic object has an external surface; said external surface is furnished with at least one grove engirdling said domestic object's perimeter; said electronic device comprising (a) a bipolar source of electrical energy; and, (b) at least two conductors electrically connected to said bipolar source; said groove has a overhanging-curb-like profile; said conductors of said electronic device are placed in parallel with respect to said groove;

wherein said insect proofing is obtained by constantly providing frequently oscillated high-voltage applied by said bipolar source to said conductors such that the maximum current obtained from said bipolar source is limited to a level harmless for a man and a pet and yet unbearable by insects.

It is another object of the present invention to provide portable insect-proof domestic system comprising at least two parallel conductors embraces the fodder sack along its perimeter and prevents insect's access to stored fodder; said system is made of at least flexible materials, adapted for being fitted to various article of manufactures, containers and vessels of different circumferences, shapes and types.

It is another object of the present invention to provide the electronic insect-proof domestic system as defined above, wherein said domestic object is selected from the group consisting of a piece of furniture, an appliance, a piece of dishware.

It is another object of the present invention to provide the electronic insect-proof domestic system as defined above, wherein said domestic object is a pet dish.

It is another object of the present invention to provide the electronic insect-proof domestic system as defined above, wherein said domestic object is a picnic table.

It is another object of the present invention to provide the electronic insect-proof domestic system as defined above, wherein said domestic object is a container filled with fodder.

It is another object of the present invention to provide a method for deterring of insects, comprising steps of
a) obtaining an electronic device attachable to any domestic object; said electronic device comprising:
   ii. a bipolar source of electrical energy; and,
   iii. at least two conductors electrically connected to said bipolar source;
b) constantly providing frequently oscillated high-voltage applied by said bipolar source to said conductors such that the maximum current obtained from said bipolar source is limited to a level harmless for a man and a pet and yet unbearable by insects, thereby deterring of insects.

It is another object of the present invention to provide the method as defined above, additionally comprising of attaching said electronic device to said domestic object.

It is hence another object of the invention to disclose an electronic insect detouring device attachable to a domestic object. The detouring device comprising a bipolar source of electrical energy and at least two conductors connected to terminals of the source of electrical energy. It is in the core of the invention wherein the source of electrical energy provides high-voltage impulses applied to the conductors such that maximum short circuit current is limited at a level harmless for a man and a pet.

Another object of the invention is to disclose the conductors disposed in parallel engirdle an external perimeter of said domestic object. The conductors are spaced apart at a distance adapted for normal prevention of circuit completion without insect and circuit completion by insect's traversing the conductors.

Further object of the invention is to disclose the source of electrical energy comprising (a) a low voltage direct current source, (b) an up converter providing alternating high voltage, (c) a rectifier, and (d) a capacitor. The current source, up converter and rectifier are connected in series. Leads of the rectifier are bridged by the capacitor.

Further object of the invention is to disclose the conductors connected to leads of the rectifier.

Further object of the invention is to disclose the up converter comprising a generator of alternating pulses and a step-up transformer.

Further object of the invention is to disclose the current source that is a galvanic battery.

Further object of the invention is to disclose the current source that is a low voltage direct current power supply powered by public network.

Further object of the invention is to disclose the device comprising an electrical strap embracing the domestic object. A length of the strap is adapted for a tight attachment to the domestic object. End portions of the strap are furnished with releasable interlock able members. The strap comprises at least two conductors charged oppositely.

Further object of the invention is to disclose an electronic insect-proof domestic system comprising a domestic object and an insect detouring device. The domestic object has an external surface. The external surface is furnished with at least one grove engirdling the object perimeter. It is in the core of the invention wherein the electrical detouring device is the device according claim 1, the groove has an overhanging-curb-like profile; the conductors are placed in parallel into at least one groove.

Further object of the invention is to disclose the domestic object selected from the group consisting of a piece of furniture, an appliance, and a piece of dishware.

Further object of the invention is to disclose the domestic object that is a pet dish.

Further object of the invention is to disclose the domestic object that is a picnic table.

Further object of the invention is to disclose the domestic object that is a fodder sack.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a circuit scheme of the source of electrical energy;

FIG. 2 is a conceptual diagram of a strap-like embodiment of the electronic insect detouring device;

FIG. 3 is a conceptual view of the insect-proof domestic system;

FIG. 4 is a schematic view of the pet dish;

FIG. 5 is a diametric cross-section view of the pet dish; and

FIG. 6 is a schematic bottom view of the picnic table.

FIG. 7 is a schematic side view of the container filled with fodder protected by the electronic insect detouring device.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, is adapted to remain apparent to those skilled in the art, since the generic principles of the present invention have been defined specifically to provide an insect detouring device attachable to domestic object and method of use thereof.

The term “flightless insect” refers hereinafter to any of numerous usually small arthropod animals of the class Insecta, having an adult stage characterized by three pairs of legs and a body segmented into head, thorax, and abdomen and having no wings or only rudimentary wings. For purposes of the current invention all crawling insects and slugs are included into the group of detoured living objects.

The term “domestic objects” refers hereinafter to objects pertaining to one's house or home, or one's household or family or relating to home life.

The term “high-voltage” refers hereinafter is maximum about 24V or 36V. 36V is the highest voltage that can be applied to men (infants or adults) or pets without causing any damage. It is defined by legal regulations as “low currant”—i.e.,—it can be applied to men (infants or adults) or pets without causing any damage.

The term “about” refers hereinafter to a range of 25% below or above the referred value.

The present invention provides an electronic device for deterring insects, said electronic device being attachable to any domestic object. The electronic device comprising
(a) a bipolar source of electrical energy; and,
(b) at least two conductors electrically connected to said bipolar source;
   wherein the insect deterrence is obtained by constantly providing frequently oscillated high-voltage applied by said bipolar source to said conductors such that the maximum current obtained from said bipolar source is limited to a level harmless for men and pets.

It is well known that ants have an external armor plating (e.g., the external skeleton) named chitin. The electrical properties of chitin are alike those of Bakelite. Hence, it isolates constant current (even high currents) and causes huge damage to fuse box and different electrical devices. Furthermore, it is well known that ants and alike insect causes huge damage to food container adapted to preserve food.

It was discovered by the inventors of the present invention, that ants are not able to withstand discharge flashes of direct current. Said current, as discovered by the inventors of the present invention, penetrates said external chitin skeleton (even for a split second) and irritate the ants. Said irritation causes a mass deterrence of ants from the location from which the current was applied.

It is emphasized that said current flashes do not result in the extermination of the ants. It is also acknowledge by the inventors of the present invention that extermination of said ants will not produce the desired effect (i.e., deterrence of ants) since the ants are know to commit even suicide if it is in the best interest of the rest of the community.

Therefore, if some are exterminated, it will lead the rest to create a ‘dead ants pile’ and the rest of the ants community will ‘climb’ over said pile and thus, overcoming the ‘obstacle’.

Therefore the present invention provides means and method for deterring insects.

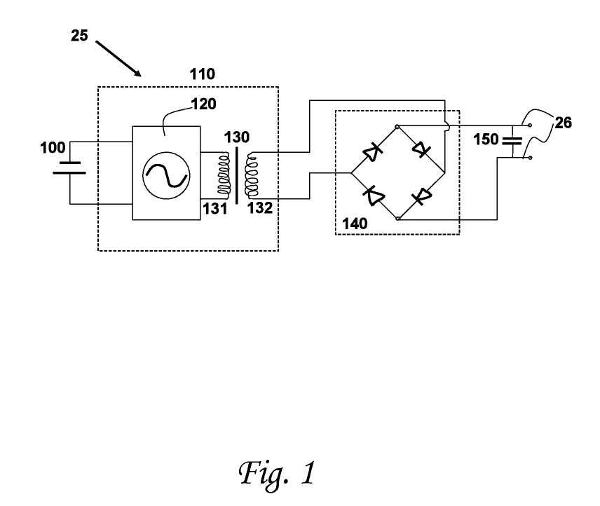

Reference is made to FIG. 1, the source of electrical energy 25 comprises a low voltage direct current source 100 preferably a galvanic battery, an up converter 110 providing alternating high voltage, a rectifier 140 preferably diode bridge, and a capacitor 150. The current source 100, the up converter 110 and the rectifier 140 are connected in series. Leads 26 of the source of electrical energy 25 are bridged by the capacitor 150. As seen from FIG. 1, the upconverter comprises a pulse generator 120 and a step-up transformer 130 with primary and secondary windings 131 and 132, respectively.

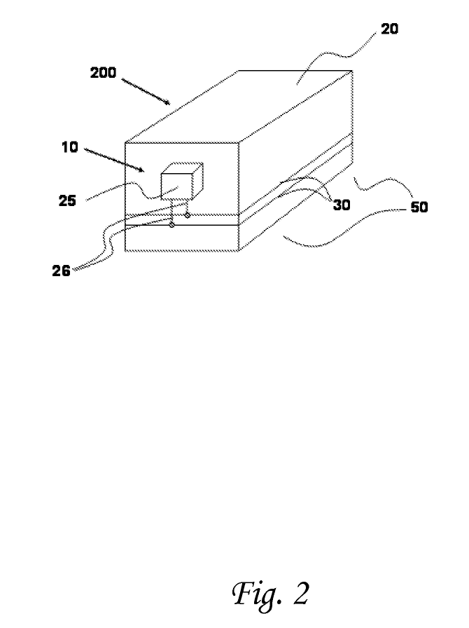

Reference is made to FIG. 2, showing a strap-like embodiment of the electrical insect detouring device. A strap 40 bearing at least two parallel conductors 30 located at a distance effective detouring insects, embraces a domestic object 20. End portions of the strap 40 are equipped with releasable interlock able members 45. A length of the strap 40 is adapted for tightly embracing the domestic object 20. The source of electrical energy 25 is secured to the domestic object 20. The source of electrical energy 25 can be secured to any internal or external surface of the domestic object 20. Securing method is not limited by an arrangement depicted in the present description.

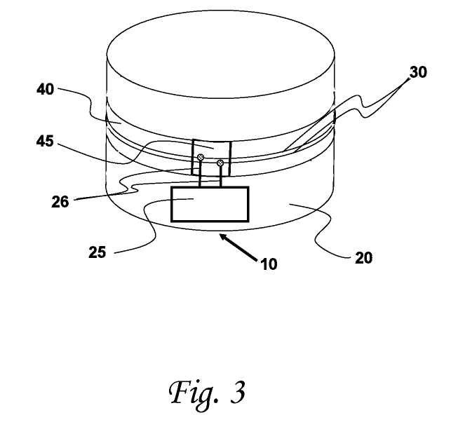

Reference is made to FIG. 3, a insect-proof domestic system 200 comprises the defended domestic object 20 placed on a floor or ground surface 50 and the electrical insect detouring device 10 secured to the domestic object 20. The conductors 30 engirdle the domestic object 20. Being connected to the output terminals 26 of the source of electrical energy 25 the conductors 30 prevent insect's access to a portion of the domestic object 20 located above the conductors 30. As mentioned above, a distance between the conductors 30 is used for circuit completion through insect's body.

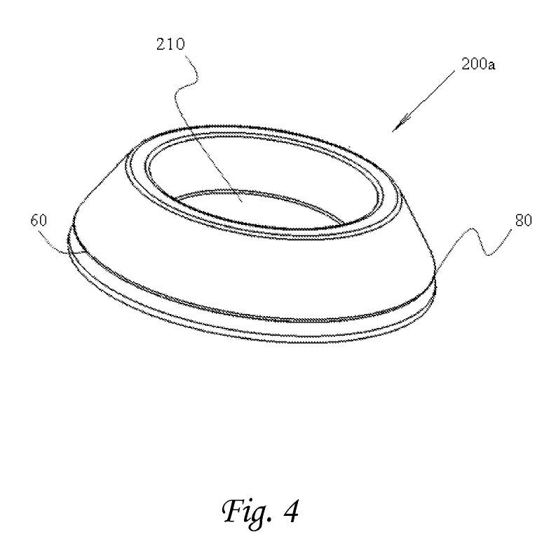

Reference is now made to FIG. 4, showing an insect-proof pet dish 200a as an example of the insect-proof system 200. The pet dish 200a has a basin for pet's food 210 and furnished at external side surface with a groove 60 of an overhanging-curb-like profile. The conductors 30 (not shown) are placed in the grove 60.

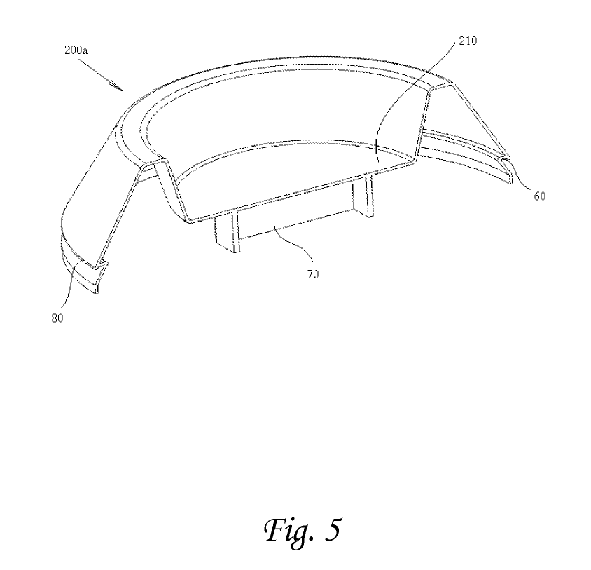

Reference is now made to FIG. 5, showing a groove 60 in details. A diametric cross section of the pet dish 200a presented in FIG. 5 reveals a cavity 70 for the source of electrical energy 25 (not shown).

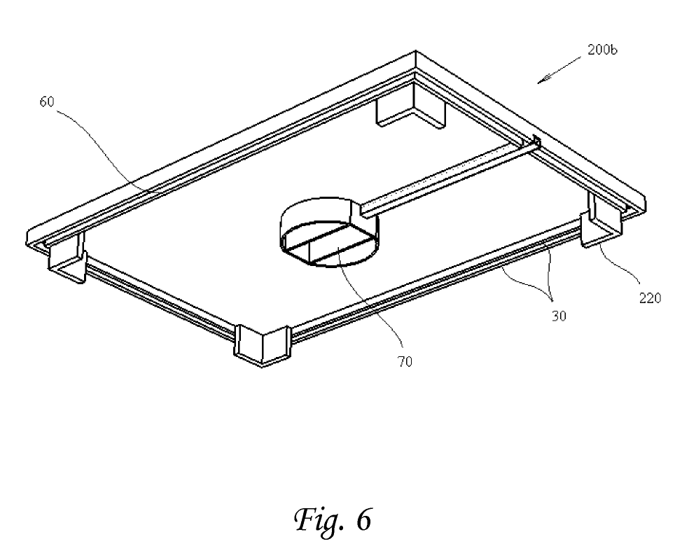

Reference is now made to FIG. 6, showing an insect-proof picnic table 200b. The groove 60 is placed along a table perimeter. The conductors 30 placed in the groove 60 prevent insect's access to human food in outdoor conditions.

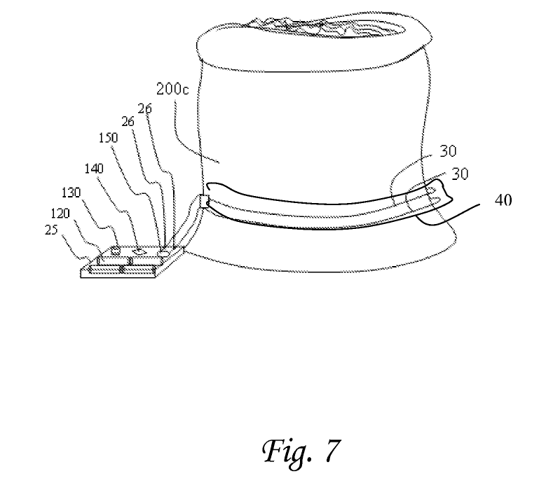

Reference is now made to FIG. 7, showing an insect-proof fodder sack 200c. At least two parallel conductors 30 embraces the fodder sack 200c along its perimeter and prevents insect's access to stored fodder. It is hence in the scope of the present invention wherein the electronic device for detouring of insects as defined above is made of at least partially flexible materials, adapted e.g., for fitting containers and vessels of various circumferences, shapes and types. The flexibility may be provided by rubber-like materials, straps etc.

As known human and animal store food and use it as bait for all kinds of vermin residing in a human house. Insects penetrate into containers used for provision storage and spoil it. Additionally, food reserve such as sacks filled with grain or animal fodder stored at farms is vulnerable to insect invasion.

In accordance with the embodiment of the invention the pulse generator 120 powered by the galvanic battery 100 provides alternate voltage pulses to the primary winding 131 of the transformer 130 (see FIG. 1). The alternate high voltage pulses induced in the secondary winding 132 are rectified by the rectifier 140 constituting a diode bridge. Rectified high voltage pulses are provided to the conductors 30. The charged capacitor 150 bridges the output terminals 26 of the sours of electrical energy 25. The conductors 30 are spaced apart at a distance adapted for normal prevention of circuit completion without insect and circuit completion by insect's traversing the conductors 30. Thus, the capacitor 150 discharges through insects' body detouring traversing insects. A working voltage created on the capacitor 150 is defined as 24 V. This voltage is completely harmless for a man and a pet.

In accordance with another embodiment of the invention the generator 120 is powered by low voltage commercially available power supply further powered from public network.

In accordance with further embodiment of the invention the insect detouring device 10 constitutes the strap 40 embracing the domestic object 20. The end portions of the strap 40 are furnished with the releasable interlock able members 45. The strap 40 embraces a perimeter of the domestic object 20. The length of the strap 40 is adapted for tough attachment to the domestic object 20. The conductors 30 located on the strap 40 and energized by the source of electrical energy 25 prevent traversing them by the insects.

In accordance with further embodiment of the invention the domestic object 20 and the insect detouring device 10 form the insect-proof domestic system 200. As seen in the FIG. 3, the system 200 located on the ground/floor surface 50 is protected against insect's access from the surface 50 to an upper portion of the domestic object 20. The conductors 30 detour insects traversing them.

In accordance with further embodiment of the invention the insect-proof pet dish 200a is furnished with the groove 60 of overhanging-curb-like profile. As seen in the FIG. 5 the conductors 30 are placed on the upper surface of the groove 60. The apron 80 creates an additional physical barrier for insects. The electrified conductors 30 placed in the groove 60 engirdling the perimeter of the pet dish 200a provide reliable protection for pet food disposed in the basin 210 (see FIG. 5).

In accordance with further embodiment of the invention the insect-proof picnic table 200b is furnished with the groove 60 located along its perimeter. Being disposed on the ground surface the table 200b prevents insects' penetration into food located on the table surface in outdoor conditions. The insects climbing along legs 220 are detoured by the conductors 30 places in the groove 60.

Hence, the suggested technical solution provides liable protection of the domestic objects against flightless insects including ants. Using high voltage pulses enables enhancement of electrical detouring effect.

1. An electronic device for deterring insects, said electronic device being attachable to any domestic object; said electronic device comprising
(a) a bipolar source of electrical energy; and,
(c) at least two conductors in electrical communication with said bipolar source;
wherein said insect deterrence is obtained by constantly providing frequently oscillated high-voltage applied by said bipolar source to said conductors such that the maximum current obtained from said bipolar source is limited to a level harmless for men and pets.

2. The electronic device according to claim 1, wherein said conductors being disposed in parallel engirdle an external perimeter of said domestic object; said conductors are spaced apart at a distance adapted for normal prevention of circuit completion without insect and circuit completion by insect's traversing said conductors.

3. The electronic device according to claim 1, wherein said source of electrical energy comprises (a) a low voltage direct current source, (b) an up converter providing alternating high voltage, (c) a rectifier, and (d) a capacitor; said current source, up converter and rectifier are connected in series; leads of said rectifier are bridged by said capacitor.

4. The electronic device according to claim 3, wherein said conductors are connected to leads of said rectifier.

5. The electronic device according to claim 2, wherein said up converter comprises a generator of alternating pulses and a step-up transformer.

6. The electronic device according to claim 2, wherein said current source is a galvanic battery.

7. The electronic device according to claim 2, wherein said current source is a low voltage direct current power supply powered by public network.

8. The electronic device according to claim 1, wherein said device comprises an electrical strap embracing said domestic object; a length of said strap is adapted for a tight attachment to said domestic object; end portions of said strap are furnished with releasable interlock able members; said strap comprises at least two conductors charged oppositely.

9. An electronic insect-proof domestic system comprising a domestic object and at least one electronic device; said domestic object has an external surface; said external surface is furnished with at least one grove engirdling said domestic object's perimeter; said electronic device comprising (a) a bipolar source of electrical energy; and, (b) at least two conductors electrically connected to said bipolar source; said groove has a overhanging-curb-like profile; said conductors of said electronic device are placed in parallel with respect to said groove;
wherein said insect proofing is obtained by constantly providing frequently oscillated high-voltage applied by said bipolar source to said conductors such that the maximum current obtained from said bipolar source is limited to a level harmless for men and pets.

10. The electronic insect-proof domestic system according to claim 9, wherein said domestic object is selected from the group consisting of a piece of furniture, an appliance, a piece of dishware.

11. The insect-proof domestic system according to claim 9, wherein said domestic object is a pet dish.

12. The insect-proof domestic system according to claim 9, wherein said domestic object is a picnic table.

13. The insect-proof domestic system according to claim 9, wherein said domestic object is a container filled with fodder.

14. A portable insect-proof domestic system comprising at least two parallel conductors embraces the fodder sack along its perimeter and prevents insect's access to stored fodder; said system is made of at least flexible materials, adapted for being fitted to various article of manufactures, containers and vessels of different circumferences, shapes and types.

15. A method for deterring of insects, comprising steps of
a) obtaining an electronic device attachable to any domestic object; said electronic device comprising:
i. a bipolar source of electrical energy; and,
ii. at least two conductors electrically connected to said bipolar source;
b) constantly providing frequently oscillated high-voltage applied by said bipolar source to said conductors such that the maximum current obtained from said bipolar source is limited to a level harmless for men and pets, thereby deterring of insects.

16. The method according to claim 14, additionally comprising of attaching said electronic device to said domestic object.
